(19) United States
(12) Patent Application Publication
(10) Pub. No.: US 2006/0104462 A1
(43) Pub. Date: May 18, 2006

(54) Crossover circuit for reducing impedance response variance of a speaker

(76) Inventor: Kenneth H. Humphreys, Eugene, OR (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(21) Appl. No.: 11/280,514

(22) Filed: Nov. 16, 2005

Related U.S. Application Data
(60) Provisional application No. 60/629,627, filed on Nov. 18, 2004.

(51) Int. Cl. H04R 3/00

(52) U.S. Cl. 381/116; 381/111; 381/99

(57) ABSTRACT

Embodiments of the present invention are directed to crossover circuits for reducing impedance response variance of a speaker. A speaker includes at least one driver and one or more electrical components. The speaker has a baseline frequency and impedance response when no associated series resistance or impedance is connected to the speaker. A pair of terminals is used for connecting the speaker to external components. Connecting the speaker to external components results in an associated series resistance or impedance, that causes the frequency response of the speaker to vary from the baseline frequency response across various frequency ranges. A crossover circuit is connected to at least one of the pair of input terminals. The crossover circuit includes electrical components configured to reduce the impedance response variance inherent to the speaker, thus reducing variances in the frequency response caused by impedances and resistances placed in series with the speaker.

### CROSS-REFERENCE TO RELATED APPLICATIONS

The present application claims priority from U.S. Provisional Patent Application Ser. No. 60/629,627, filed Nov. 18, 2004, and entitled “Crossover Circuit”, which provisional application is incorporated herein by reference in its entirety.

### BACKGROUND

### 1. Background and Relevant Art

Many speakers include a “crossover circuit”, an electrical network consisting of capacitor(s), resistor(s) and/or inductor(s). The crossover circuit divides the wide audio frequency spectrum into limited bandwidths appropriate for the individual frequency-specialized drivers (woofers, mid-ranges, tweeters, etc). The crossover circuit also equalizes the energy being fed to the drivers to tailor the sound character in a desired way.

However, the crossover in combination with the drivers, produces an impedance that fluctuates significantly as a function of frequency. As a result, a speaker's tonal balance, often referred to as frequency response, is affected by external resistances, such as, for example, another speaker or speaker wire, connected in series to the speaker. Thus, the speaker may play louder at one frequency (e.g., 2 Khz) and softer at another frequency (e.g., 200 Hz) even though other settings (e.g., the volume) remain essentially constant.

### BRIEF SUMMARY

Embodiments of the present invention are directed to crossover circuits for reducing impedance response variance of a speaker. A speaker includes at least one driver and one or more electrical components. The speaker has a baseline impedance and frequency response when no associated series resistance or impedance is connected to the speaker. A pair of terminals is used for connecting the speaker to external components. Connecting the speaker to external components results in an associated series resistance or impedance that causes the frequency response of the speaker to vary from the baseline frequency response. A crossover circuit is connected to at least one of the pair of input terminals. The crossover circuit includes electrical components configured to reduce the frequency response variance caused by connecting the external components.

These and other objects and features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which

FIG. 1A illustrates a speaker system including a crossover circuit that reduces impedance response variance of a speaker.

FIG. 1B illustrates the speaker system of FIG. 1A with a more detailed example embodiment of the crossover circuit that reduces impedance response variance of the speaker.

FIG. 1C illustrates the speaker system of FIG. 1A with another more detailed example embodiment of the crossover circuit that reduces impedance response variance of the speaker.

FIG. 2 illustrates graphical plots of produced impedance at various frequencies for different configurations of a speaker system.

FIG. 3 illustrates a plot of the baseline frequency response of a speaker having no associated series resistance.

FIG. 4 illustrates plots of frequency response variance from the plot in FIG. 3 for differently configured speaker systems.

### DETAILED DESCRIPTION

Embodiments of the present invention are directed to crossover circuits for reducing impedance response variance of a speaker. A speaker includes at least one driver and one or more electrical components. The speaker has a baseline impedance and frequency response when no associated series resistance or impedance is connected to the speaker. A pair of terminals is used for connecting the speaker to external components. Connecting the speaker to external components results in an associated series resistance or impedance that causes the frequency response of the speaker to vary from the baseline frequency response. A crossover circuit is connected to at least one of the pair of input terminals. The crossover circuit includes electrical components configured to reduce the frequency response variance caused by connecting the external components.

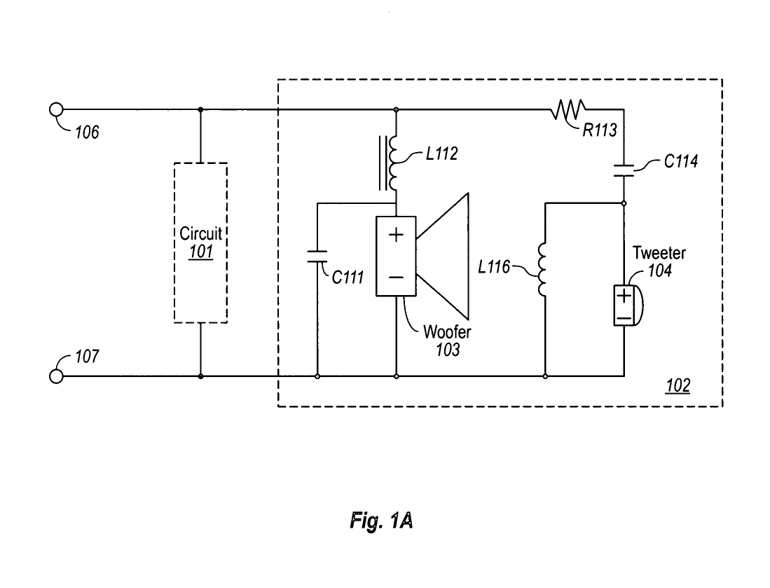

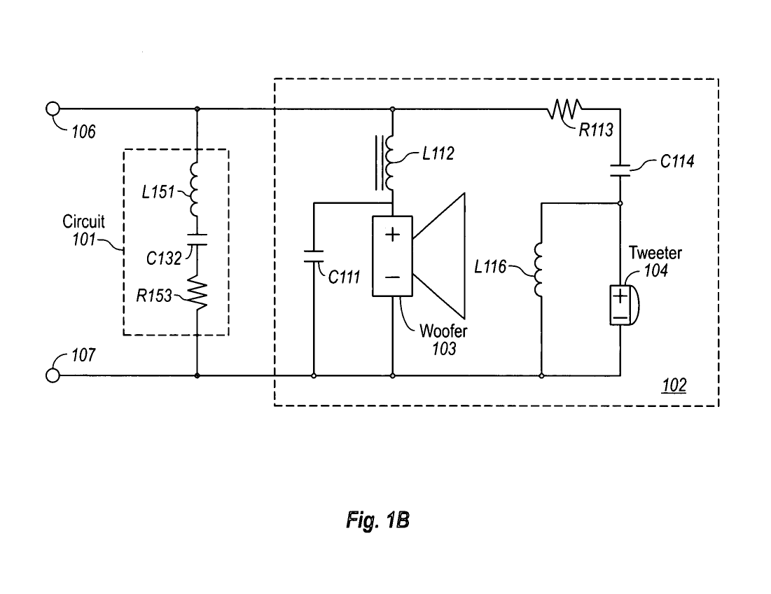

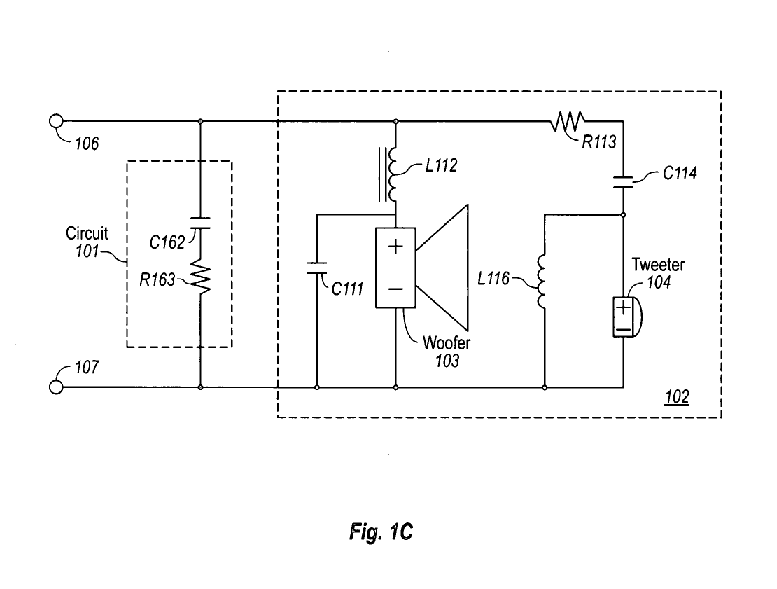

For example, FIG. 1 illustrates a crossover circuit 101 for reducing impedance response variance of two-way speaker 102. Two-way speaker 102 includes woofer 103 and tweeter 104. Woofer 103 and tweeter 104 are connected to another and to input terminals 106 and 107 by various circuitry components, including capacitor inductor L112, resistor R113, capacitor C114, and inductor L116. Crossover circuit 101 is connected across the input terminals 106 and 107 of the two-way speaker 102 and provides an impedance in parallel with the impedance of the two-way speaker 102.

The impedance of the crossover circuit 101 can be configured (or tuned) for a specified frequency range based on the values of the components in two-way speaker 102. Within the specified frequency range, crossover circuit 101 reduces fluctuation in the produced impedance of two-way speaker 102. That is, based on the values and measurement units of capacitor 111, inductor 112, resistor 113, capacitor 114, inductor 116 and the electrical characteristics of woofer 103 and tweeter 104, crossover circuit 101 can be configured (or tuned) to reduce impedance fluctuation of two-way speaker 102 within a specified frequency zone.

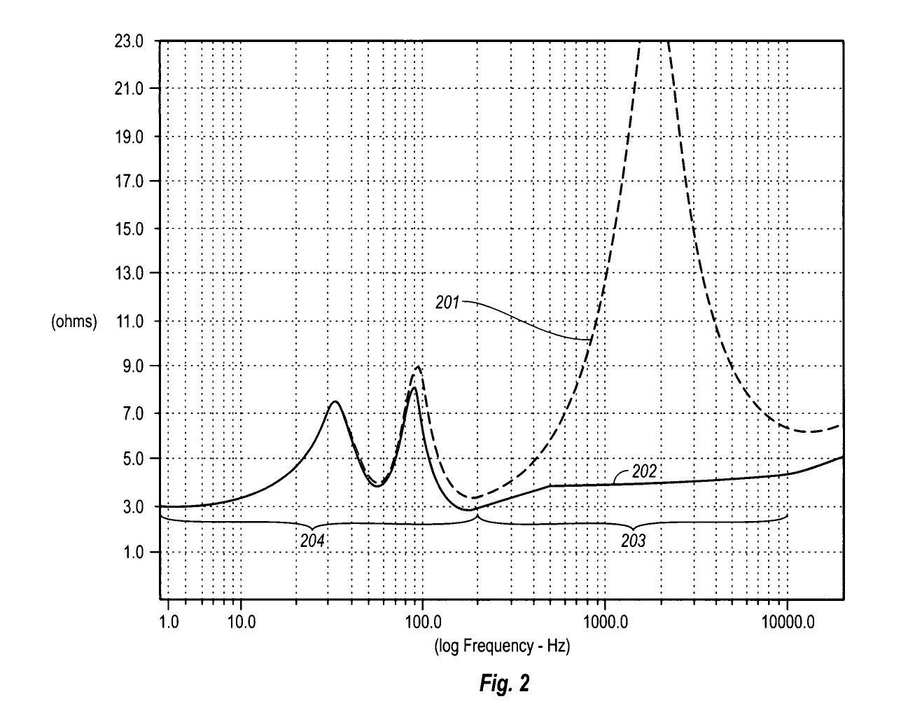

FIG. 2 illustrates graphical plots of produced impedance at various frequencies for different configurations of a speaker system, for example, similar to two-way speaker 102. Plot 201 represents the frequency response of the speaker system when the speaker system does not include a crossover circuit configured to reduce impedance fluctuation. As depicted by plot 201, the produced impedance of the speaker system fluctuates at different frequency ranges.

For example, impedance fluctuations occur between approximately 4 Hz and 200 Hz, indicated by range 204 in FIG. 2. As depicted, the produced impedance of the speaker system raises from approximately 3 ohms to 7 ohms across an approximate frequency range of 4 Hz to 30 Hz, falls from approximately 7 ohms to 4 ohms across an approximate frequency range of 30 Hz to 60 Hz, raises from approximately 4 ohms to 8 ohms across an approximate frequency range of 60 Hz to 100 Hz, and then falls from approximately 8 ohms to 3 ohms across an approximate frequency range of 100 Hz to 200 Hz.

More significant impedance fluctuations occur between approximately 200 Hz and 10 kHz, indicated by range 203 in FIG. 2. As depicted, the produced impedance of the speaker system raises from approximately 3 ohms to over 23 ohms across an approximate frequency range of 200 Hz to 20 kHz and then falls from over 23 ohms to approximately 6 ohms across an approximate frequency range of 2 kHz to 10 kHz

Plot 202 represents the impedance response of the speaker system when the speaker system includes a crossover circuit configured to reduce impedance fluctuation (e.g., crossover circuit 101). The cross over circuit can be configured (or tuned), through selection of various electrical components (e.g., resistors, capacitors, inductors, etc.) having specified characteristics (e.g., 4 ohms, 90 microfarads, 2.0 millihenries, etc.), to produce the result of reducing impedance fluctuation across range 203. The selected electrical components of crossover circuit may be connected in series and/or in parallel with one another.

As depicted for plot 202, the impedance fluctuation is similar to plot 201 across range 204. However, impedance fluctuation is significantly reduced across range 203. As depicted, across an approximate frequency range of 200 Hz to 10 kHz the impedance rises from approximately 3 ohms to 5 ohms, a fluctuation of approximately 2 ohms. Thus, over a specified frequency range (range 203), the impendence fluctuation of a speaker system that includes a configured (or tuned) crossover circuit (represented by plot 202) is significantly less than the fluctuation of the same speaker system without the configured (or tuned) crossover circuit (represented by plot 201). Thus, this reduction in impedance variance can result in a corresponding reduction in frequency response variance when series resistances or impedances are connected in series to a speaker.

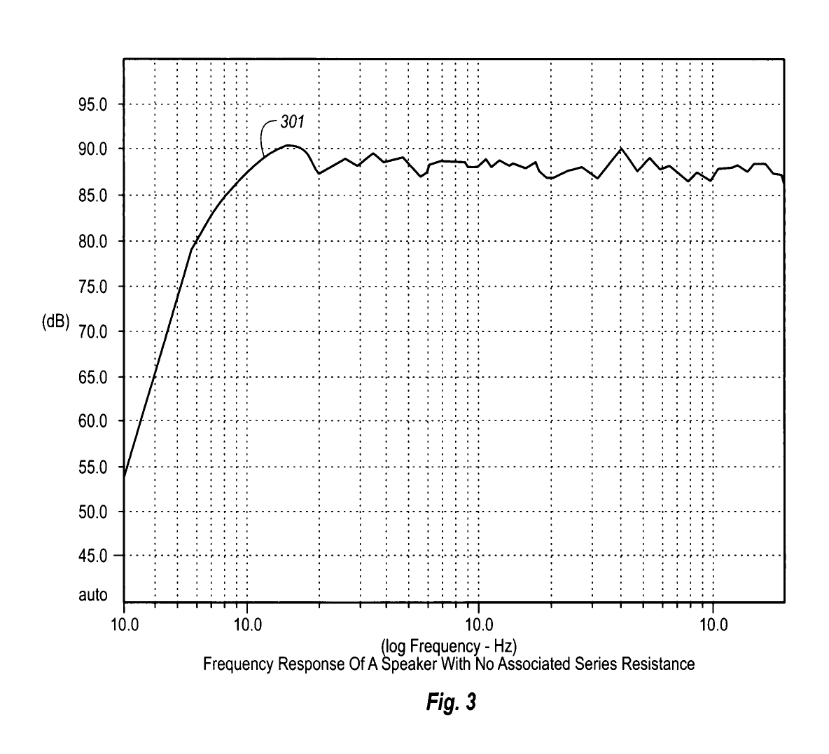

FIG. 3 illustrates a plot 301 of the frequency response of a speaker having no associated series resistance. As depicted, the frequency response is approximately the same, varying by approximately 4 db, across the range from 100 Hz to 10 kHz.

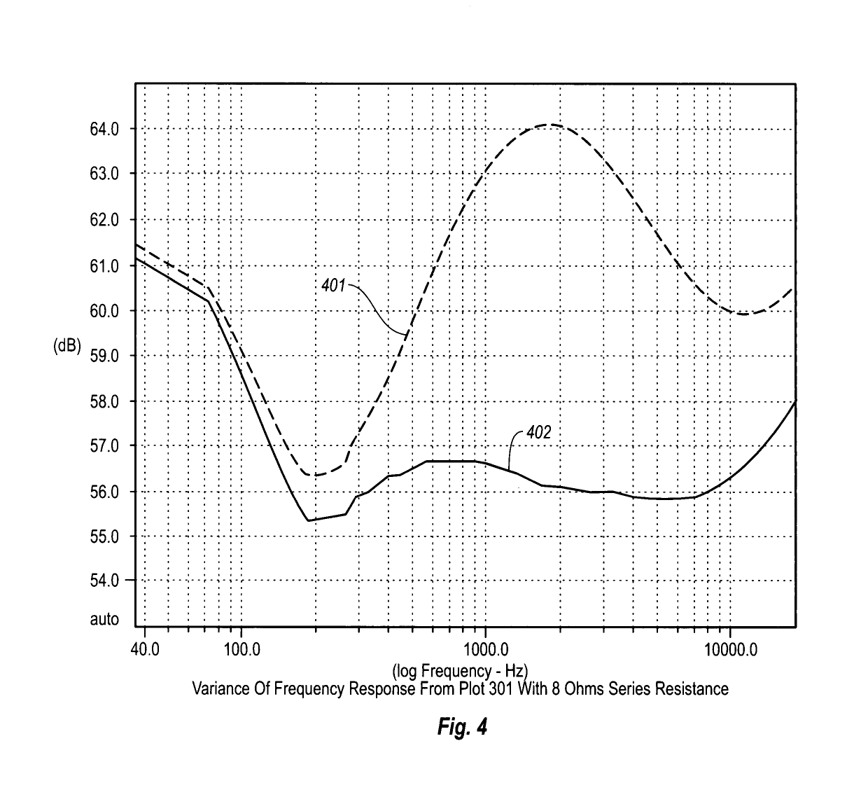

FIG. 4 illustrates plots 401 and 402 of frequency response variance from the frequency response depicted in FIG. 3. Plot 401 represents the frequency response variance from plot 301 for the same speaker with 8 ohms of associated series resistance. Plot 402 represents the frequency response variance from plot 301 for the same speaker with 8 ohms of associated series resistance and including a configured (or tuned) crossover circuit (similar to crossover circuit 101). As depicted in FIG. 4, the frequency response variance of the speaker including the configured (or tuned) crossover circuit (plot 402) is less than the frequency response variance of the speaker not including the configured (or tuned) crossover circuit (plot 401) at all plotted frequencies. Thus, the output characteristics (e.g., volume) of a speaker including a configured (or tuned) crossover circuit are more consistent across a range of frequencies, such as, for example, range 203.

FIG. 1B illustrates the speaker system 102 with a more detailed embodiment of the crossover circuit 101 that reduces frequency response variance of the speaker. As depicted in FIG. 1B, crossover circuit 101 includes inductor L151, capacitor C152, and resistor R153. Based on the characteristics of the components in speaker system 102, the characteristics of the components of crossover circuit 101 can be configured (or tuned) to reduce impedance fluctuation and thus also reduce frequency response variance. For example, when the characteristics of components of speaker system 102 are similar to:

C111: 15 uF, 100V, <10% DF

L112: 1.0 mH, <0.50 ohms, 10 mm×10 mm×58 mm laminated “I” core

R113: 3 ohms, 10 watt

C114: 4.7 uF, 100V, Myler

L116: 0.40 mH, <0.30 ohms, air core

Woofer 103: 5″, 4 ohms

Tweeter 102: 1″, 4 ohms

The characteristics of components in crossover circuit 101 can be configured (or tuned) similar to:

L151: 0.10 mH, <0.30 ohms, air core

C132: 90 uF, 100V, <10% DF

R153: 4 ohms, 10 watt

to flatten out the impedance response of speaker system 102 when the impedance spikes around a particular frequency. Accordingly, the frequency response of speaker system 102 is less susceptible to variance due to series resistances and/or impedances, such as, for example, speaker wire and other speakers, connected to speaker system 102. Use of crossover circuit 101 including components with the above listed values can result in plots similar to plot 202 and plot 402 when series resistances and/or impedances are connected to speaker system 102.

FIG. 1C illustrates the speaker system 102 with another more detailed embodiment of the crossover circuit 101 that reduces impedance response variance of the speaker. As depicted in FIG. 1C, crossover circuit 101 includes C162 and R163. The characteristics of C162 and R163 can be configured (or tuned) to “flatten out” impedance that rises with frequency.

Accordingly, the various crossover circuits in FIGS. 1A, 11B, and 1C can be configured (or tuned) to mitigate the inherent impedance fluctuation of the speaker (e.g, inherent in the speaker's design). Reduced impedance fluctuation can result in corresponding reduced frequency response variances when impedances or resistances are in series with the speaker, thereby improving speaker performance. It would be apparent to one skilled in the art, after having reviewed this description, that crossover circuit 101 can include components with a variety of characteristics and the components can be configured in a variety of different ways. Configuring components of crossover circuit 101 can include connecting components to one another in both series and in parallel arrangements.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A speaker system for reducing impedance response variance of a speaker, the system comprising:
a speaker including at least one driver and one or more electrical components;
a pair of terminals for connecting to external components, connection of external components resulting in series impedance that fluctuates across various frequency ranges; and
a crossover circuit connected to at least one of the pair of input terminals, the crossover circuit including electrical components configured to reduce impedance fluctuation across at least one of the various frequency ranges.

2. The speaker system of claim 1, wherein the speaker comprises a woofer and a tweeter.

3. The speaker system of claim 1, wherein the pair of input terminals are for connecting to speaker wire.

4. The speaker system of claim 1, wherein the pair of input terminals are for connecting to other speakers.

5. The speaker system of claim 1, the crossover circuit is connected across the pair of input terminals in parallel with the speaker.

6. The speaker system of claim 1, wherein the crossover circuit comprises a resistor and capacitor tuned to reduce impedance fluctuation across a specified frequency range.

7. The speaker system of claim 1, wherein the crossover circuit comprises a resistor, capacitor, and inductor tuned to reduce impedance fluctuation across a specified frequency range

8. The speaker system of claim 1, wherein the crossover circuit comprises electrical components configured to reduce impedance fluctuation of the speaker in a frequency range from approximately 600 Hz to 10 kHz.

9. A speaker system for reducing frequency response variance of a speaker, the system comprising:
a speaker including at least one driver and one or more electrical components, the speaker having a baseline impedance response when no associated series resistance is connected to the speaker;
a pair of terminals connecting the speaker to external components, connection to the external components resulting in an associated series resistance that causes the frequency response of the speaker to vary from the baseline frequency response across various frequency ranges; and
a crossover circuit connected to at least one of the pair of input terminals, the crossover circuit including electrical components configured to reduce the inherent impedance response variance of the speaker.

10. The speaker system of claim 9, wherein the speaker comprises a woofer and a tweeter.

11. The speaker system of claim 9, wherein the pair of input terminals are for connecting to speaker wire.

12. The speaker system of claim 9, wherein the pair of input terminals are for connecting to other speakers

13. The speaker system of claim 9, the crossover circuit is connected across the pair of input terminals in parallel with the speaker.

14. The speaker system of claim 9, wherein the crossover circuit comprises a resistor and capacitor tuned to reduce impedance response variance of the speaker across a specified frequency range.

15. The speaker system of claim 9, wherein the crossover circuit comprises a resistor, capacitor, and inductor tuned to impedance response variance of the speaker across a specified frequency range

16. The speaker system of claim 9, wherein the crossover circuit comprises electrical components configured to reduce impedance fluctuation of the speaker in a frequency range from approximately 600 Hz to 10 kHz.

17. A speaker system for reducing impedance response variance of a speaker, the system comprising:
a speaker including at least one driver and one or more electrical components, the speaker having a baseline frequency response when no associated series resistance is connected to the speaker;
a pair of terminals for connecting to external components, connection of external components resulting in an associated series resistance that causes the frequency response of the speaker to vary from the baseline frequency response across various frequency ranges; and
circuitry means connected to the speaker system for reducing the impedance response variance from the baseline impedance response of the speaker.

18. The speaker system of claim 17, wherein the circuitry means is configured to flatten out an impedance that rises with frequency.

19. The speaker system of claim 17, wherein the circuitry means is configured to mitigate an impedance that peaks at a specified frequency.

20. The speaker system of claim 17, wherein the circuitry means is tuned to mitigate impedance response variance across a specified range of frequencies.
